(19) United States
(12) Patent Application Publication
(10) Pub. No.: US 2006/0045709 A1
(43) Pub. Date: Mar. 2, 2006

(54) Patient lift with support legs that spread over two ranges of motion

(76) Inventors: Colin C. Bain, Longmont, CO (US); Nigel Heales, Telford (GB); David Genske, Westminster, CO (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/911,916

(22) Filed: Aug. 5, 2004

(51) Int. Cl. B65G 47/90

(52) U.S. Cl. 414/626

(57) ABSTRACT

A portable patient lift has spreadable support legs with a feature that enables the legs of the lift to operate in a first range of motion during operation, and a second range of motion for compact folding.

### BACKGROUND OF INVENTION

This invention relates in general to hoisting equipment and more particularly, to a portable lifting apparatus for lifting and transferring incapacitated persons.

Lifting devices are well known. Such devices typically include a base, a mast extending upwardly from the base, and a boom extending forwardly from the mast. The boom generally supports a carriage by which the patient can be completely suspended from the lifting device. Rollers depending from the base enable the device and thus the patient to be transferred.

Size (i.e., length and width) of a lifting device contributes to the stability (or instability) of the device and its ability to be easily navigated. The ability of the lift device to be folded into a compact form contributes to its ease of transportation and storage. It is well known to provide lift devices with legs that open and close by operation of a foot pedal. Prior art lifts have legs that operate to open and close over a single range of motion. There is no definitive differentiation between the motion of the legs when the legs are moved to an opened position (i.e., during operation of the lift) and when the legs are moved to the closed position (i.e., during transportation and storage of the lift). If the legs are not sufficiently opened during operation of the lift, the stability of the lift may be affected and the patient's safety may be compromised. If the legs do not close sufficiently, then ease in transportation and storage of the lifting device may be affected.

A portable patient lift is needed with spreadable support legs having a feature that enables the legs to be sufficiently opened during operation of the lift and sufficiently closed into a compact form for transportation and storage.

### SUMMARY OF INVENTION

The present invention is directed towards a portable patient lift that has spreadable support legs with a feature that enables the legs of the lift to operate in a first range of motion during operation, and a second range of motion for compact folding.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a front perspective view of a portable patient lift according to a preferred embodiment of the invention.

FIG. 2 is a rear perspective view of the portable patient lift illustrated in FIG. 1.

FIG. 3 is a top plan view of the portable patient lift with legs in a first or narrow-open leg position.

FIG. 4 is a top plan view of the portable patient lift with legs in a second or wide-open leg position.

FIG. 5 is a top plan view of the portable patient lift with legs in a folded position so that the lift is in a compact form.

FIG. 6 is an exploded top perspective view of a mechanical controller according to a preferred embodiment of the invention.

FIGS. 7A-7D are diagrammatic representational views in rear elevation of a portion of the mechanical controller throughout operation thereof.

FIG. 8 is a front elevational view of the mechanical controller with a spring thereof engaging an end of an engagement pin to urge an opposing end thereof down.

### DETAILED DESCRIPTION

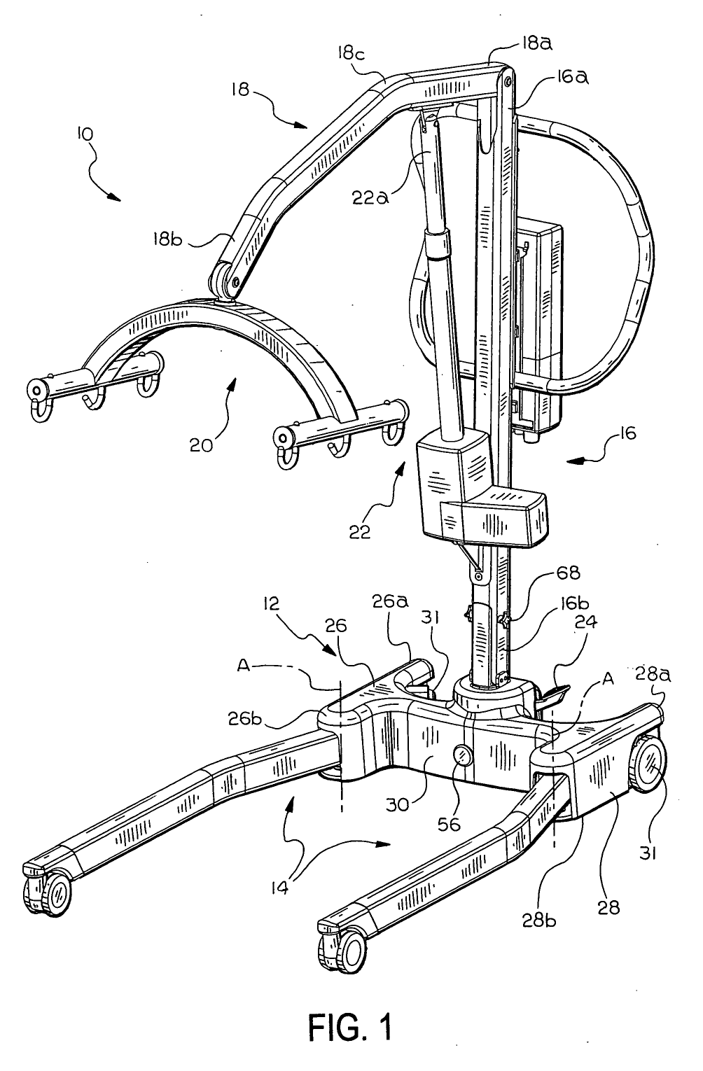

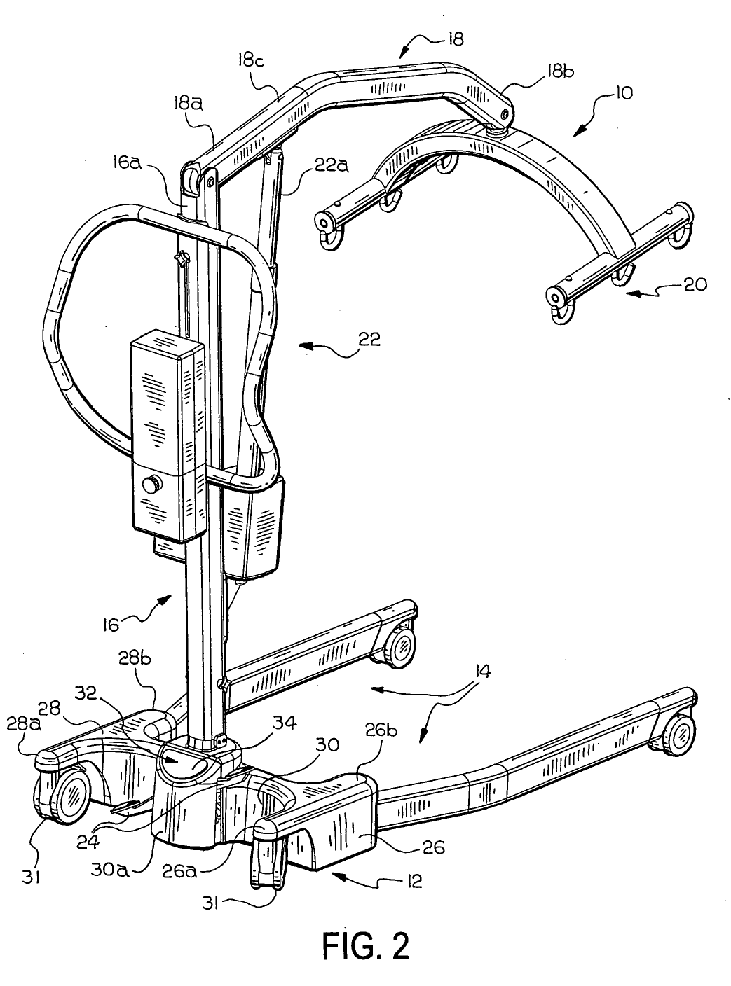

Referring now to the drawings, there is illustrated in FIGS. 1 and 2 a portable lift, generally indicated at 10. The lift 10 preferably includes a base 12, a pair of spreadable support legs 14 extending horizontally from the base 12, a mast 16 extending vertically from the base 12, and a boom 18 extending forwardly from an upper end 16a of the mast 16. The mast 16 is preferably not telescopic, but rather a single piece. The boom 18 is pivotally connected at one end 18a (shown in FIG. 1) to the mast 16, and the boom 18 has a cradle 20 at its other end 18b (shown in FIG. 1) for lifting a patient. An actuator 22 is mounted part way up the height of the mast 16, and is connected at its far end 22a (shown in FIG. 1) to an intermediate portion 18c (shown in FIG. 1) of the boom 18 so that actuation of the actuator 22 pivots the boom 18 relative to the mast 16.

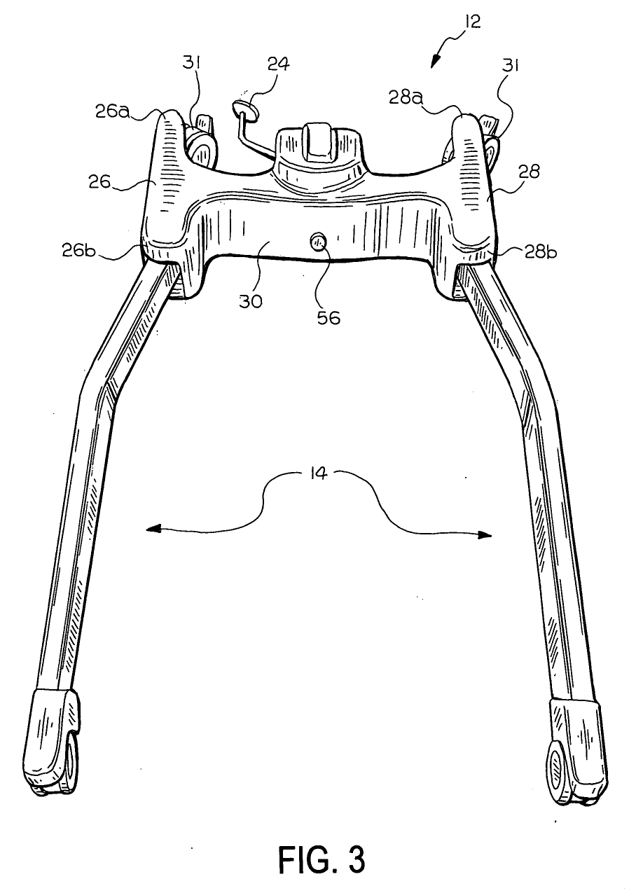

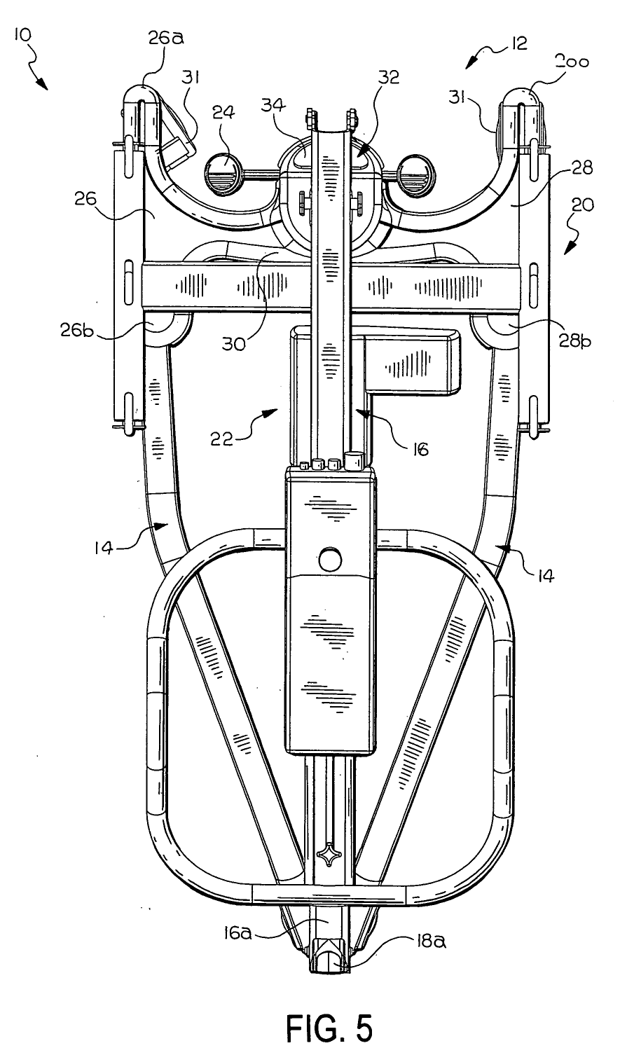

During operation, the support legs 14 can be spread open and closed, as shown in FIGS. 3-5, respectively, to accommodate the operating needs of the lift 10. The opening and closing motion is accomplished by operation of a foot pedal 24. The lift can be folded into a compact form (shown in FIG. 5) by collapsing the support legs 14 together, pivoting the boom 18 down so that it is substantially parallel with the mast 16, and pivoting the mast 16 downward toward or onto the base 12 to assume a position nearly parallel with the support legs 14 and the ground or other support surface.

The illustrated base 12 is generally H-shaped, having left and right blocks 26, 28 oriented in a forward/rearward direction, and having a central connecting body or rib 30 extending laterally between the left and right blocks 26, 28. Each block 26, 28 has a rearward end 26a, 28a from which caster wheels 31 are mounted for rotation. A forward end 26b, 28b of the blocks 26, 28 provides a mounting point for the support legs 14, wherein the support legs 14 may be rotatable on a vertical axis A (shown in FIG. 1) for spreading and closing relative to each other.

As illustrated in FIG. 2, the central rib 30 has a rearward side 30a (i.e., facing the operator) with an integrated foot push pad 32 with an angled face 34 suitable for the operator to apply foot pressure when moving or manipulating the lift 10. Force from the operator's foot gives the operator extra leverage and/or control when moving or manipulating the lift 10. With the push pad 32 integrated into the base 12, and having a high-friction surface, the operator's foot will be less likely to slip off the base 12 than if no foot push pad were provided.

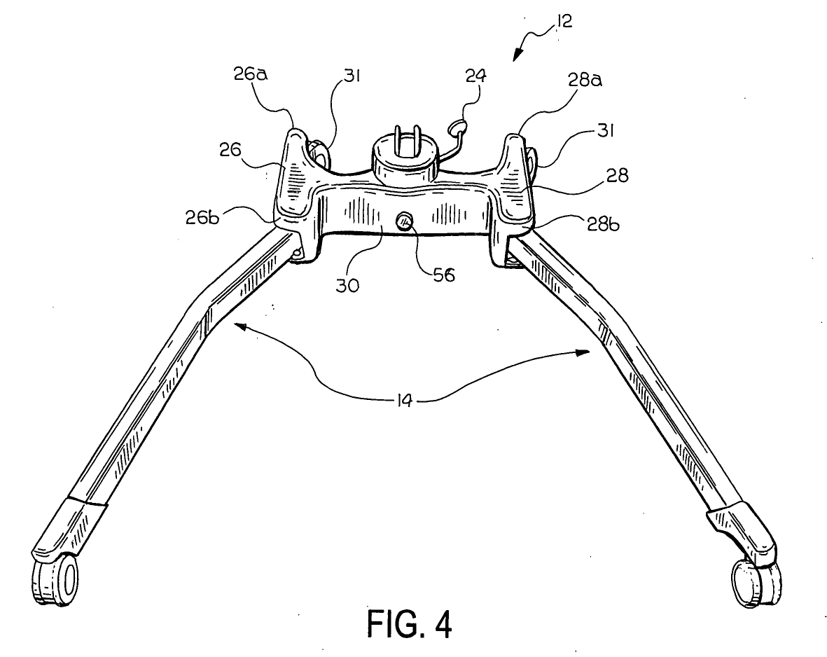

In operation, the legs 14 operate in a first range of motion during operation, and a second range of motion for compact folding. The legs 14 preferably operate in unison so that when one leg 14 spreads open, the other spreads open as well. As illustrated in FIG. 3, the legs 14 are operable to move to a first or narrow-open leg position. In FIG. 4, the legs 14 are moved to a second or wide-open leg position. In FIG. 5, the legs 14 are closed to a folded position, so that the lift is in a compact form.

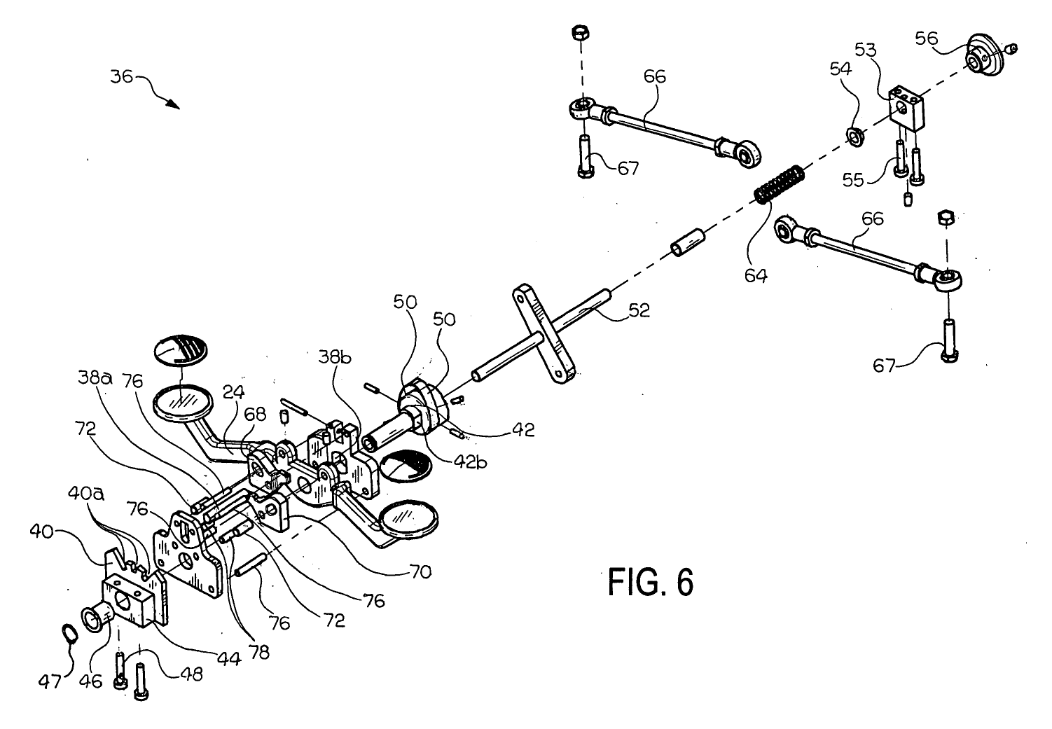

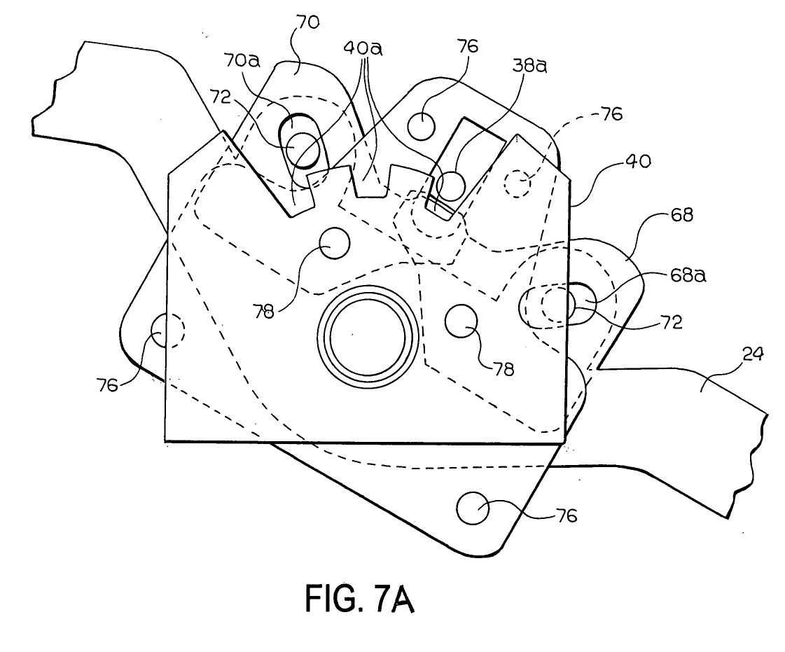

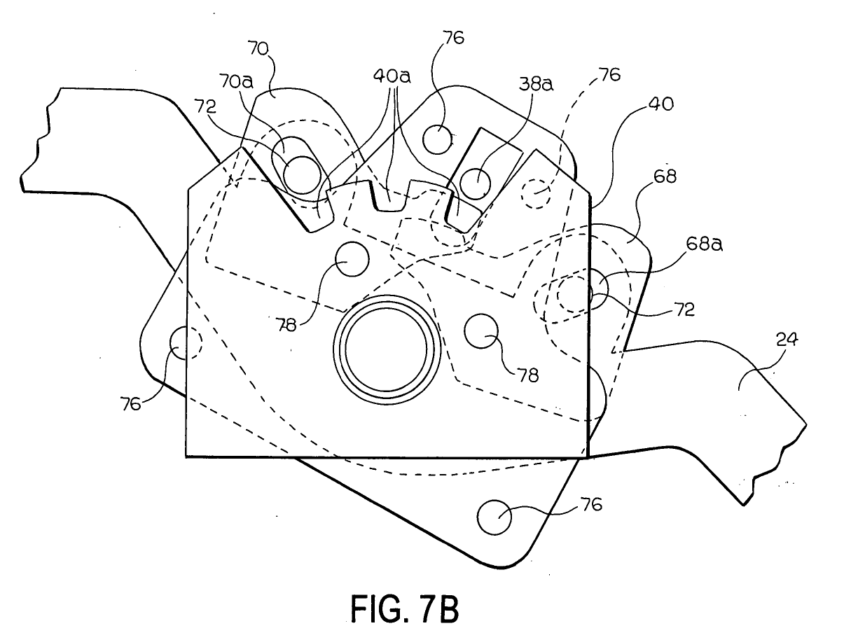

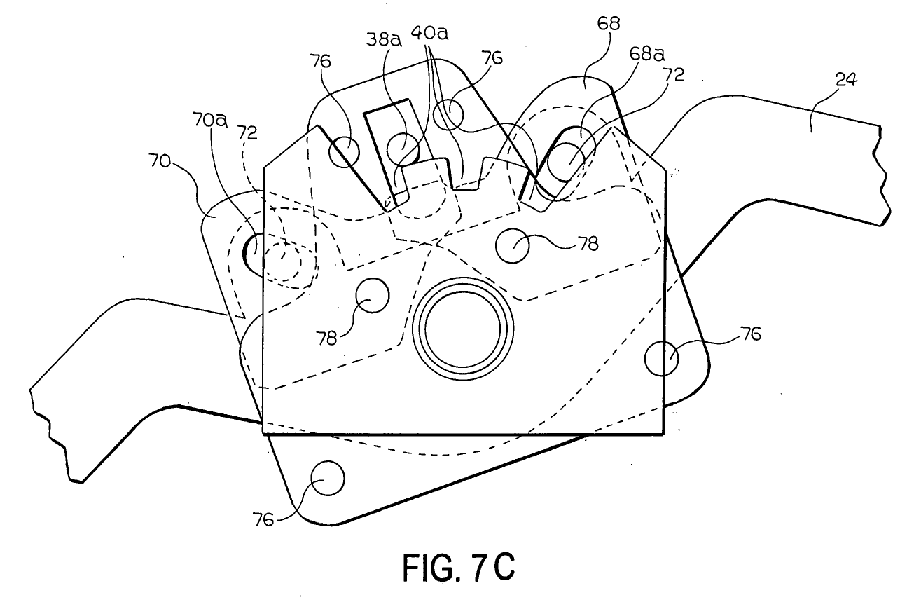

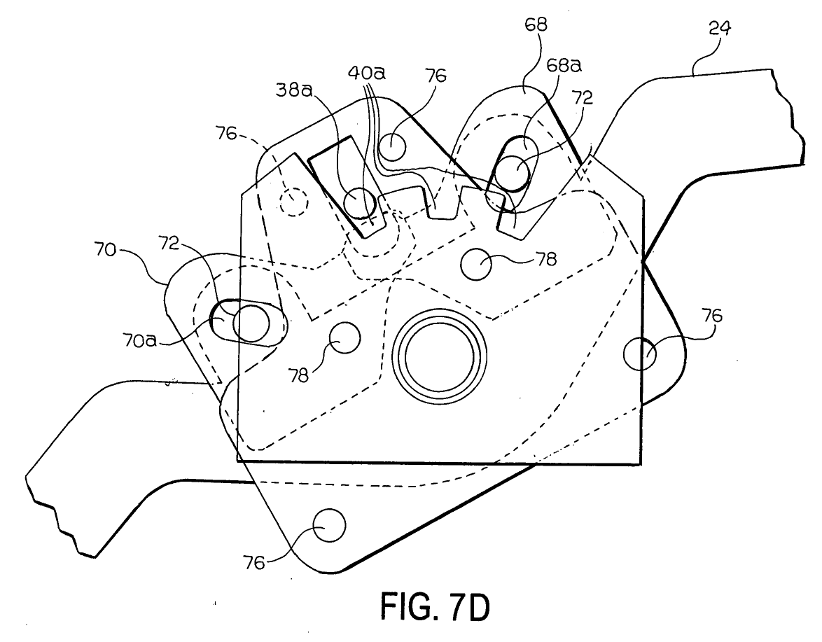

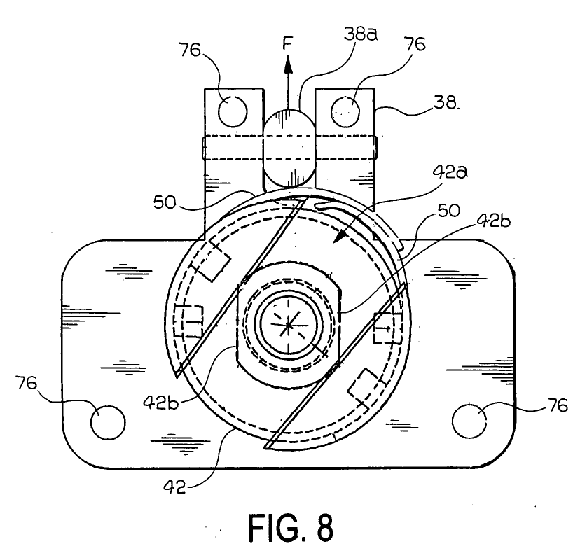

A mechanical controller 36, as shown in FIG. 6, is situated within the rib 30 of the base 12 for controlling the spreading and collapsing of the support legs 14 during operation of the lift. The mechanical controller 36 includes an inboard movable (i.e., rotatable) member or plate 38 with that pivotally supports an engagement pin 38a that is selectively engageable with one of a plurality of grooves or slots 40a in a fixed or non-movable member or plate 40, as shown in FIGS. 7A-7D. The inboard movable plate 38 is supported in relation to the fixed plate 40, such as by the leg rotation member 42 shown. The leg rotation member 42 is supported for movement relative to a rear-mounting block 44, such as by the bushing 46 shown, and held in a fixed axial position relative to the rear-mounting block 44, such as by the C-clip 47 shown. The rear-mounting block 44 is held in a fixed relation to the rear end of the rib 30, for example, by threaded fasteners 48. The fixed plate 40 is held in a fixed position relative to the rear-mounting block 44, such as by welding or otherwise fixing the fixed plate 40 to the rear-mounting block 44. One or more springs 50, such as the spring plates shown, are adapted to be held in compression between the leg rotation member 42 and the engagement pin 38a, as shown in FIG. 8. The springs 50 operate to urge one end of the engagement pin 38a up, which, in turn, urges an opposing end of the engagement pin 38a down into one of the slots 40a in the fixed plate 40. The engagement pin 38a and slot 40a cooperate to form an anti-back drive to prevent inadvertent collapse of the legs 14 when the lift 10 is carrying a patient. That is to say, the engagement pin 38a is prevented from inadvertently becoming dislodged from the slot 40a by a force F exerted on the engagement pin 38a by the spring 50.

As shown in the drawings, the front end of the leg rotation member 42 is supported by a slideable shaft 52 that extends through a front-mounting block 53 and further through the front end of the rib 30. The slideable shaft 52 is supported for rotation relative to the front-mounting block 53, such as via the bushing 54 shown. The front-mounting block 53 is held in fixed relation to the front end of the rib 30, for example, by threaded fasteners 55. The slideable shaft 52 extends into the leg rotation member 42. Attached to a portion of the shaft 52, exposed through the front end of the rib 30, is a knob 56. The slideable shaft 52 is operable in a first position, wherein a link 52a supported by the slideable shaft 52 engages the leg rotation member 42 to permit the operation of the support legs 14 via the first range of motion, wherein the legs 14 are selectively movable to the first leg position shown in FIG. 3 or the second leg position shown in FIG. 4, as will be explained in the description that follows. By pulling the knob 56 forward in a direction away from the rib 30, the link 52a is axially displaced relative to the leg rotation member 42 to permit the operation of the legs 14 via the second range of motion. In the second range of motion, the legs 14 can be fully closed for compact folding, as shown in FIG. 5. A spring 64, which is carried by the shaft 52 between the link 52a and the front-mounting block 53, urges or returns the link 52a back into engagement with the leg rotation member 42 for displacing the legs 14, as will be clearly understood from the description that follows.

As clearly shown in the drawings, the link 52a has opposing ends pivotally connected to opposing tie rods 66, to which the legs 14 are pivotally coupled, such as, for example, via the shoulder bolts 67 shown. The link 52a has an irregular shape and is adapted to engage an irregular shaped opening or channel 42a (shown in FIG. 8) in the leg rotation member 42. The leg rotation member 42 is fixed relative to the inboard movable plate 38, such as by the flat surfaces 42b that engage flat surfaces 38b in the inboard movable plate 38. In a preferred embodiment of the invention, the link 52a and the channel 42a are preferably irregular in shape (e.g., tapered), but may otherwise be configured so as to mate with one another when the link 52a and the channel 42a are aligned in a particular orientation. When the link 52a is engaged with the channel 42a, the foot pedals 24 (shown in FIG. 1) via foot action of the operator's foot may rotate the inboard movable plate 38, which in turn rotates the link 52a to move the tie rods 66. The tie rods 66, in turn, move the legs 14 in the first range of motion. That is to say, with the link 52a engaging the channel 42a, the legs 14 can be moved between the first leg position and the second leg position. To move the legs 14 in the second range of motion, wherein the legs can be collapsed to the closed position, the knob 56 is pulled forward and away from the rib 30. This disengages the link 52a from the channel 42a to allow the link 52a to move independently of the channel 42a to collapse the legs 14. A spring 64 is held in compression between the front-mounting block 53 and the link 52a for urging the link 52a back into engagement with the channel 42a when the knob 56 is released and the link 52a is properly aligned with the channel 42a. This once again allows the legs 14 to move in the first range of motion.

The mechanical controller 36 shown includes left and right leg rotation plates 68 and 70 that are supported for sliding movement relative to the foot pedal 24 by leg rotation plate pins 72. The leg rotation plate pins 72 are fixed relative to the foot pedal 24 and displaceable in slots 68a, 70a in the leg rotation plates 68, 70. An outboard movable plate 74 is held in a fixed position relative to the inboard movable plate 38 by pins 76. The leg rotation plates 68, 70 are pivotally supported relative to the outboard movable plate 74 by pivot pins 78. The inboard and outboard movable plates 38 and 74 house the foot pedal 24 and the leg rotation plates 68, 70 therebetween.

In operation, the engagement pin 38a is located in a slot 40a in the fixed plate 40. Upon depressing the foot pedal 24 (i.e., in a counter-clockwise direction when viewing FIGS. 7A-7D), the leg rotation plates 68 and 70 rotate upward to engage the engagement pin 38a and raise the engagement pin 38a out of the slot 40a. Further depression of the foot pedal 24 causes the inboard and outboard movable plates 38 and 74 to rotate. Continued depression of the foot pedal 24 causes the engagement pin 38a to move in a counter-clockwise direction until the engagement pin 38a is radially aligned with another slot 40a. Still further depression of the pedal 24 causes the spring 50 to urge an end of the engagement pin 38a up, as shown in FIG. 8, which urges the opposite end of the engagement pin 38a down into another slot 40a. In the former slot 40a, the support legs 14 are in the first or narrow-open leg position and in the latter slot 40a, the support legs are in the second or wide-open leg position, as discussed above.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A portable patient lift comprising:
an anti-back drive; and
support legs with a disengagement feature, which enables the legs to operate in a first range of motion during operation, and a second range of motion for compact folding.

2. A lift according to claim 1 wherein the legs do not lock when folded.

3. A lift according to claim 1 wherein disengagement of the legs from the anti-back drive is effected with a control knob.

4. A lift according to claim 1 wherein the legs, in the first range of motion, operate between at least a first position and a second position.

5. A lift according to claim 4 wherein the legs, when in the first position, are in a narrow-open position, and when in the second position, are in a wide-open position.

6. A lift according to claim 1 further comprising a mechanical controller for controlling the operation of the support legs.

7. A lift according to claim 6 wherein the mechanical controller includes a movable member and a fixed member, the movable member pivotally supporting a pin that is selectively engageable with one of a plurality of slots in the fixed member.

8. A lift according to claim 7 wherein one or more springs are adapted to be held in compression against the pin to urge the pin into one of the slots in the fixed member.

9. A lift according to claim 7 further comprising:
a slideable shaft supporting a link; and
a leg rotation member supported in relation to the slideable shaft, the slideable shaft being operable in a first position, wherein the link engages the leg rotation member to permit the operation of the support legs via the first range of motion, and a second position, wherein the link disengages the leg rotation member to permit the operation of the legs via the second range of motion.

10. A lift according to claim 9 wherein the link is connected to the support legs.

11. A lift according to claim 9 further comprising a spring for urging the link back into engagement with the leg rotation member.

12. A lift according to claim 9 wherein the link has an irregular shape and is adapted to engage an irregular shaped channel in the leg rotation member.

13. A lift according to claim 9 wherein the link and the leg rotation member are configured so as to mate with one another to align in a particular orientation.

14. A lift according to claim 9 further comprising at least one rotation plate supported relative to a pedal, whereby upon depressing the pedal, the leg rotation plate engages the pin to raise the pin out of a first one of the slots and causes the movable plate to rotate until the pin is aligned with a second one of the slots, and whereby a spring urges the pin into the second slot.

15. A lift according to claim 6 further comprising a base, the mechanical controller being situated within the base.
